(19) United States
(12) Patent Application Publication
(10) Pub. No.: US 2003/0000730 A1
(43) Pub. Date: Jan. 2, 2003

(54) Reliable connecting cable

(76) Inventors: Sui K. Kwok, Tseung Kwan O (HK); Richard C. H. Lee, Tseung Kwan O (HK)

Correspondence Address: William R. McClellan, Wolf, Greenfield & Sacks, P.C., Federal Reserve Plaza, 600 Atlantic Avenue, Boston, MA, 02210, US

(21) Appl. No.: 10/082,560

(22) Filed: Feb. 25, 2002

(30) Foreign Application Priority Data
Feb. 26, 2001 (GB) 0104736.4

(51) Int. Cl. H01B 7/08

(52) U.S. Cl. 174/117 F

(57) ABSTRACT

The invention relates to an electrical cable for electrical connection, typically in electronic displays such as liquid crystal displays, comprising a conductive element and an insulator therefor, characterised in that the insulator on one surface is interrupted over its length whereby to provide mechanical stability of the conductive element and to adapt the cable for electrical connection with another electrical device. The cable in the embodiment has a conductive layer and an upper and lower insulating layer, a gap in the upper insulating layer, (as considered in use) defines the interrupted insulator through which the conductive layer is exposed for connection with the another electrical device.

The invention relates to an electrical cable, which can also be a lead, flying connection or connecting cable. For example, it can be a flexible flat cable (FFC) or a flexible printed circuit (FPC) or its derivatives. A connecting cable does not necessarily mean a flat laminate. It can be a laminate wrapped around a fibre cable/rod constituting the outer surface, and the like.

These connection cables are often used for interconnection between two electrical/electronic devices. (It will be understood that the term electrical used herein is also taken to mean electronic). Thus connecting cables have been extensively adopted in many branches of electronics. They are required to be low cost, with high reliability mechanically, with good electrical contact, and safe. In most applications, the connecting cable may be used together with a connector which holds the ends of a cable by means of metallic clips. The connecting cable may sometimes be inserted into and pulled out from the connector several times. This in-and-out action may cause loose electrical contact problems. This fault is normally seen if a poor quality cable is used.

One of the promising applications of connecting cables is in electronic displays including flat panel displays like liquid crystal displays (LCDs) and organic light emitting diodes (OLEDs). Other examples are electrochromic mirrors and light shutters. The connecting cables are a means of connecting the display electrodes to the circuitry, electrical signals being transmitted to the display electrodes via the connecting cables. The connecting cable is usually attached to the display electrodes at the end of the connecting cable, electrical conduction between the connecting cable and the display electrodes being ensured by conductive adhesive (e.g. anisotropic conductive films). At the other end of the connecting cable on the circuitry, the connecting cable is usually inserted into a connector on the circuitry. The connecting cable may be inserted into and pulled out from the connector several times. This in-and-out action causes a loose electrical contact problem which may not be detected at the beginning but open-circuit may occur later, after say some period of vibration. This problem normally happens especially when poor quality connecting cable is inserted into the connector. One of the reasons is that there is some peeling or delamination between the conductive layer and the bottom insulating layer. This results in a reduction in contact area between the conductive layer of the connecting cable and the conductive head of the connector.

It is an object of the invention to seek to mitigate these disadvantages and to provide a connecting cable which is mechanically reliable and has good electrical contact over a period of use.

According to a first aspect of the invention there is provided an electrical cable, comprising a conductive element and an insulator therefore, the insulator on one surface being interrupted over its length whereby to provide mechanical stability of the conductive element and to adapt the cable for electrical connection with another electrical device.

The interrupted insulator may comprise a gap through which the conductive element is exposed for connection with the another electrical device. This is a relatively simple yet efficient construction.

The conductive element may comprise a conductive layer and the insulator may comprise an upper and lower insulating layer, the gap being in one layer of the upper and lower insulating layer. This provides a relatively simple yet effective cable, particularly when the gap may be in the upper layer, (as considered in use). A user can readily see the gap and readily connect the cable to another device.

The conductive layer may comprise a plurality of conductive strips, which may comprise a desired number, width and pitch. This construction provides an optimum form of cable.

The gap may be adjacent one end of the cable. This provides for relatively simple connection to another device.

The gap may extend across the whole width of the cable. This provides for a relatively simple cable which may be manufactured relatively readily.

There may be a plurality of gaps in the insulator, particularly there may be two gaps in the insulator.

The gaps may be adjacent opposite ends of the cable.

The upper and lower insulating layers may comprise part of an integral insulating sleeve of the conductive element. This provides a relatively simple construction.

According to a second aspect of the invention there is provided an electrical device, electrically connected with an electrical cable as hereinbefore defined.

The electrical device may comprise a connector.

An electrical cable embodying the invention is hereinafter described, by way of example, with reference to the accompanying drawings.

FIG. 1 shows a side elevational cross section of a conventional connecting cable;

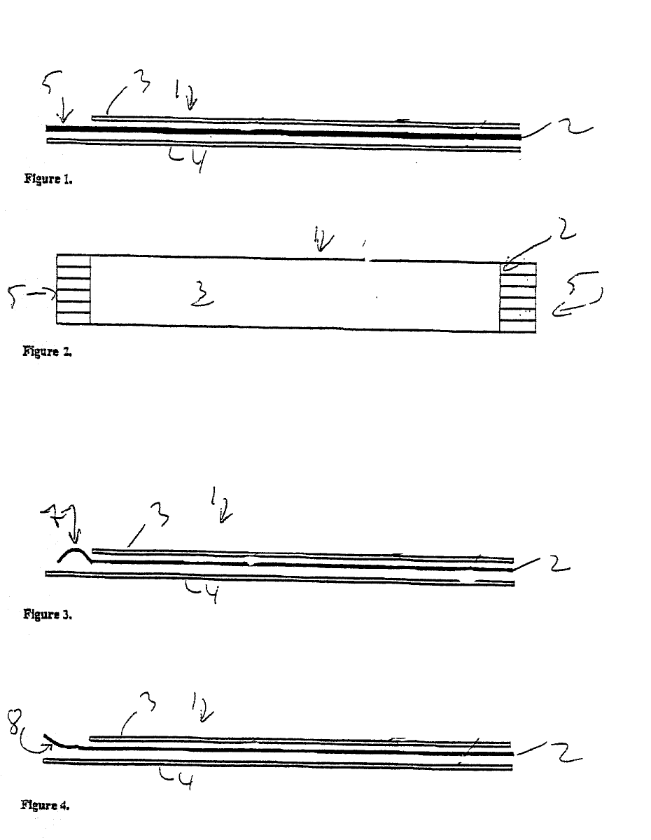

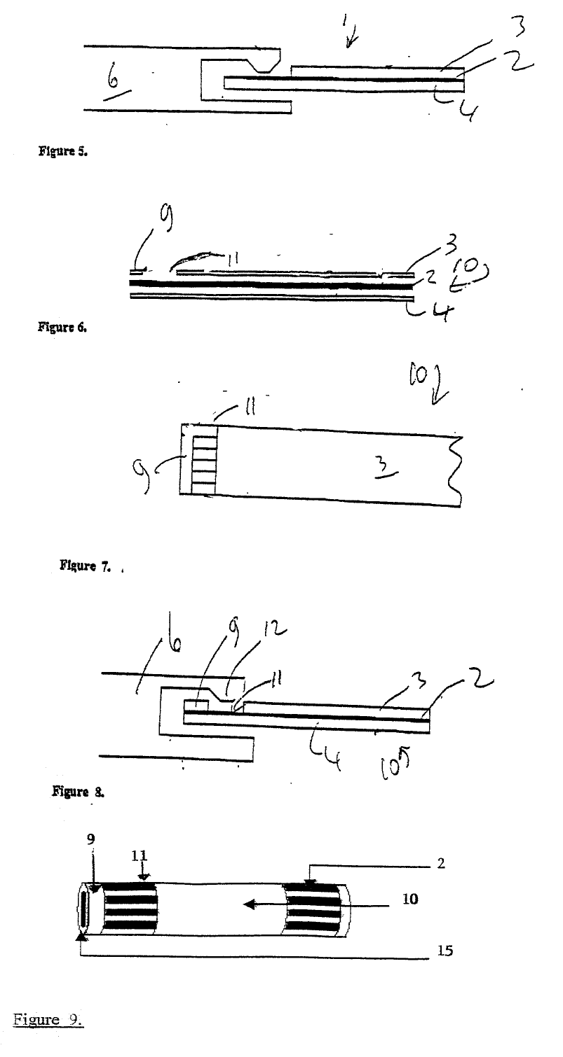

FIG. 2 shows a top elevational view of a conventional connecting cable;

FIG. 3 and

FIG. 4 show examples of failure modes in weak electrical contact due to the peeling or delamination of the conductive layer of a conventional connecting cable;

FIG. 5 shows an application of a conventional connecting cable to a connector;

FIG. 6 shows a side elevational cross section of a connecting cable according to the invention;

FIG. 7 is a top elevational view of the connecting cable of FIG. 6;

FIG. 8 shows application of the connecting cable of FIGS. 6 and 7 to an electrical device such as a connector; and

FIG. 9 shows a connecting cable according to a further embodiment of the invention.

Referring to FIGS. 1 to 5, there is shown a conventional connecting cable 1. It typically has a layer of conducting material 2 consisting of long electrical conductors or conductive strips sandwiched between upper and lower (as viewed) insulating layers 3,4 of plastic. At one or each end of the cable 1 part of the upper, in the case shown, insulating layer is removed to provide an exposed end part 5 of the conducting material by which the cable 1 can be connected to another electrical device 6. In this cable, the number of conductive strips corresponds to the number of channels for electrical signal transmission. The top view of a conventional connecting cable is shown in FIG. 2. There are some situations where the connecting cables lose mechanical reliability and electrical contact. One of the reasons is that the conductive layer 2 is slightly delaminated and peeled end as shown respectively in FIGS. 3 and 4. This delaminated conductive layer may cause a reduction in contact area for electrical signal conduction. Thus in FIG. 3 the conductive layer is delaminated from the lower insulating layer at 7, and in FIG. 4 is peeled off therefrom at 8 both due to repeated pushing in and pulling out from another electrical device 6. Even though no open-circuit may be detected at the beginning, an open-circuit situation may appear after some period of mechanical vibration.

In most situations, the connecting cables are used with a connector 6. FIG. 5 shows schematically the connection of a conventional connecting cable with a connector. One advantage of using a connector is that the user can separate and re-connect the connecting cable to the connector conveniently. The connecting cable is inserted into the connector for electrical connection and pulled out from the connector for electrical opening between the two devices. This multiple insertion/pulling action may cause some mechanical reliability and electrical contact problems. This peeling (FIG. 4) or delamination (FIG. 3) problem normally occur after inserting poor quality connecting cable into a connector. A connecting cable 10 embodying the invention seeks to solve this reliability problem with a simple and manufacturable design. The implementation is simple and the manufacturing process is basically similar to the present production method. The method is to not remove the top insulating layer down to the edge but to interrupt part of one surface of the insulator to leave a small margin 9 at the edge of the top insulating layer 3 at the end of the cable thereby defining a gap 11 is shown in FIG. 6 and FIG. 7 which are respectively a cross section and top view of one edge of a connecting cable 10 embodying the invention. FIG. 9 shows a further embodiment of the invention in which the connecting cable 10 is wrapped around an inner fibre cable/rod 15.

The small margin 9 provides a protective mechanism against delamination of the conductive layer 2 and reduces the occurrence of peeling of the conductive layer 2 so as to improve the mechanical reliability and electrical contact of the cable 10 overall. The protective mechanism is thus this thin insulating strip or margin 9 at the edge of one end of the cable covering the conductive layer 2 but leaving sufficient area or gap 11 for the conductive layer to be exposed for making electrical connection with another device 6. The width of the margin 9 of the top insulating layer 3 is determined by the location of a clip or head 12 from the innermost end of the connector as shown in FIG. 8 where the connection cable 10 embodying the invention is inserted into a connector 6. Since the thickness of the top insulating layer 3 is very thin the margin 9 does not cause any difficulty during the insertion of the cable 10 into the connector.

It will be understood that an electrical cable as described herein with reference to FIGS. 6 to 8 has improved mechanical reliability and electrical contact over conventional electrical cables. The connecting cable of FIGS. 6 to 8 can be of any desired arbitrary dimension, arbitrary number of conducting strips in the conductive layer and arbitrary pitch of the conductive strips in that layer. The conductive layer is protected by the top insulating layer, to the end of the cable, against peeling off or delamination of the conductive layer form the bottom insulating layer. As a result, the conductive layer is less easy to be separated from the bottom insulating layer and hence more mechanically reliable.

It will be understood too that connecting cables are often used in electrical displays for connecting the display electrodes and the electronic circuitry. One end is usually connecting to the display electrodes by conductive adhesives (e.g. anisotropic conductive film). The other end is usually connecting to the electronic circuitry by soldering or by means of connectors. In order to connect the cable to a connector, the cable is inserted into the connector. Electrical connection is effected by the contact between the conductive layer of the cable and the conductive head of the connector. This electrical connection is terminated by pulling out the cable from the connector. This connection/disconnection action may usually be carried out several times. This in-and-out action may cause some separation, peeling or delamination between the middle conductive layer and the bottom insulating layer. As a result, the mechanical contact between the connector and the cable is not firm and reliability is weakened. Open-circuit may happen after some period of vibration. The cable embodying the invention increases the protection against separation between the middle conductive layer and bottom insulating layer and, hence, provides better electrical contact and reliability between the connector and the connection cable.

In short some advantages of the present invention are as follows:

1. An electrical cable may be a connecting cable consisting of a conductive layer sandwiched between two insulating layers. The cable may be of a laminate form or a fibre form. The middle conductive layer is made by conductive strip(s). The conductive strip(s) can be of arbitrary number, arbitrary widths and arbitrary pitch. The whole conductive layer is covered by the top and bottom insulating layers except part of the area is exposed for electrical connection between two devices.

2. An electrical cable in the form of a fibre cable/rod can be of arbitrary cross-sectional shape, length and hardness. An example of such a cable is made by wrapping an electrical cable in a (flat) laminate form onto a soft fibre cable/rod.

3. An electrical cable can have arbitrary shape, geometry and dimension. A usual configuration is of long rectangular shape with the exposed area on either the same or different insulating layers at two ends of the cable.

4. The electrical cable has a protective mechanism for preventing the peeling, delamination and separation of the middle conductive layer and the bottom insulating layer.

5. The protective mechanism is a strip of the top insulating material covering the rim or edge of the connector next to the conductive exposed area.

6. When a connector is used together with an electrical cable, the connecting cable is usually inserted into the connector and pulled out from the connector. This in-and-out action may reduce the mechanical reliability and the electrical contact. The electrical cables are more reliable with respect to reliable electrical contact.

7. The width of the protective mechanism of the connecting cable depends on the location of clips from the innermost of the connector when a connector is used simultaneously.

8. The connecting cable is less likely to be pulled out from the connector accidentally but has no difficulty during the insertion of the invented cable into a connector.

9. The implementation and manufacturing of the invented electrical cables is simple and the process is similar to the present production. The benefit is to strengthen the reliability against the problems mentioned above.

10. In some optical applications, (e.g. electronic displays, electrochromic mirrors, light shutters), the electrical cables can be applied. One end of the cable is connected to the display electrodes using conducting adhesives (e.g. anisotropic conducting film). The other end of the cable is connected to a circuitry via a connector.

11. The electrical or electronic devices mentioned may refer to electronic displays, other optical applications, or two circuitries. Some examples of electronic displays are flat panel displays such as liquid crystal displays (LCDs), plasma displays, organic light emitting diodes (OLEDs), and the like. Some examples of other optical applications include elechtrochromic mirrors, light shutters, and the like.

12. In such electrical or electronic devices, the electrical cable connects display electrodes on one end and a connector on the other end. The electrical conduction between the display electrodes and the electrical cable is ensured by conductive adhesives (e.g. anisotropic conductive films).

13. In the case when the electrical or electronic devices are two circuitries and the electrical cable has two ends connecting to connectors, the electrical cable can have both two ends adopting the invention with interrupted insulator defining the two gaps.

14. Advantageously, the electrical connection between the electrical cable of the present invention and a connector, is more mechanically reliable and with good electrical conduction over a period of use than conventional cables.

1. An electrical cable, comprising
(i) a conductive element;
(ii) an insulator for the conductive element;
(iii) said insulator on one surface being interrupted over its length whereby to provide mechanical stability of the conductive element and to adapt the cable for electrical connection with another electrical device.

2. An electrical cable as defined in claim 1, the interrupted insulator defining a gap through which the conductive element is exposed for connection with the another electrical device.

3. An electrical cable as defined in claim 2, the conductive element comprising a conductive layer and the insulator comprising an upper and lower insulating layer, the gap being in one layer of the upper and lower insulating layers.

4. An electrical cable as defined in claim 3, the gap being in the upper layer, (as considered in use).

5. An electrical cable as defied in claim 3, wherein the conductive layer comprises a plurality of conductive strips.

6. An electrical cable as defined in claim 5, wherein the strips comprise a desired number, width and pitch.

7. An electrical cable as defined in claim 2, wherein the gap is adjacent one end of the cable.

8. An electrical cable as defined in claim 7, wherein the gap extends across the whole width of the cable.

9. An electrical cable as defined in claim 2, wherein there are a plurality of gaps in the insulator.

10. An electrical cable as defined in claim 9, wherein there are two gaps in the insulator.

11. An electrical cable as defined in claim 10, wherein the gaps are adjacent opposite ends of the cable.

12. An electrical cable as defined in claim 2, wherein the upper and lower insulating layers comprise part of an insulating integral sleeve of the conductive element.

13. An electrical device, electrically connected with an electrical cable as defined in claim 1.

14. An electrical device as defined in claim 13, comprising a connector.
